(19) United States
(12) Patent Application Publication
(10) Pub. No.: US 2005/0268320 A1
(43) Pub. Date: Dec. 1, 2005

(54) Multifunctional entertainment system

(76) Inventor: Reginald Leland Smith, Gaffney, SC (US)

Correspondence Address: Reginald L. Smith, 412 Browning Road, Gaffney, SC, 29341, US

(21) Appl. No.: 11/124,756

(22) Filed: Aug. 9, 2005

Related U.S. Application Data
(60) Provisional application No. 60/569,576, filed on May 10, 2004.

(51) Int. Cl. H04N 7/025

(52) U.S. Cl. 725/80; 725/112; 725/103; 725/113; 725/131; 725/139

(57) ABSTRACT

A multifunctional device that has a three-part design that will give the user outstanding capabilities. One part that will be mentioned is a one-part system that will be intergraded with a plasma screen or a PLC monitor. The system includes a built-in computer, video processor. The video processor part of the system will have Hyper Thread technology along with MP-3 capabilities. The second part that will be mentioned is a two-part system that will have the previously mentioned functions. This systems base unit is compact and has the ability of a full-scale computer. This unit has a built in video processor that is the control center of the system. This part of the unit has a programmable chip. This part of the system will allow the user to control all incoming and outgoing signals. This unit will allow the user to use many different infotainment devices simultaneously. The third part that will be mentioned is a unit the size of a CD player that fits in a vehicle. This unit will consist of all the functions mentioned above. This system will be installed in the dash of a vehicle giving the passengers multiple entertainment options as well as the driver. For example, while the passengers are watching movies or playing games the driver and the front seat passenger can listen to the radio or CD simultaneously. All three units also has a memory chip and able to burn memory to a CD. These three units are the most unique on the market.

### TECHNICAL FIELD

The present invention generally relates to the home and vehicle electronics systems, such as entertainment and information control system that gives user unlimited capabilities and outstanding sound. This system is the user all in one unit.

### BACKGROUND OF THE INVENTION

Home entertainment systems are equipped with any different types of functions and capabilities. There is a wide range of entertainment systems on the market that basically function the same. This system/unit/station is designed to give the user more capabilities to perform more functions at the same time.

This system is made-up of three known components, but the unique combination and programming makes this system extremely different from all the rest.

The part of this system that is used on the desktop will have capabilities beyond an ordinary desktop system. This system also has the Hyper Thread Technology programmed in its video processor. This system also has MP-3 capability. This system consists of two parts—the unit and monitor. This unit and monitor are compact for easy portability. This unit and monitor will fit in a computer case. The unit that is designed for the vehicle will consist of just the video processor setup.

### SUMMARY OF THE INVENTION

The present invention provides the user with multiple functions and capabilities that can be performed simultaneously. These units are designed to entertain everyone in the room or vehicle. This system will operate many types of monitors (digital or analog) and all types of electronic devices, including digital cams and digital cameras. According to one aspect of the present invention, the user can access the Internet on one monitor; play a DVD movie on another monitor simultaneously while operating the Internet setting in front of the television.

Another aspect of the invention, the user can operate all the entertainment they desire without loading down or upgrading their hard drive. The computer part will handle all business attire functions while the video processor will handle all entertainment functions and it will traffic all incoming and outgoing signals.

### BRIEF DESCRIPTION OF THE DRAWINGS

This present invention relates to application No. 60/569,576 filled May 10, 2004

The present invention will now be described, by way of example, with reference to the accompanying drawings, in which:

FIG. 1 is a front view of a Plasma TV screen with multiple control devices. Its view contains, video cam and Infrared position for video cam. It also views the DVD drive position along with the Infrared for the video processor control, the Infrared for wireless keyboard and Infrared for TV control.

FIG. 2 is the rear view of a Plasma TV viewing the position were the computer/video processor unit would be installed. It also view were the ports are located.

FIG. 3 is a flow diagram illustrating a method of controlling functionality of the device according to the present invention.

FIG. 4 is a flow diagram illustrating a method in which the menu shall operate.

FIG. 5 is a rear view of the unit designed to fit in the dash of a vehicle. It also views the available ports.

FIG. 6 is a front view of the unit designed to fit in the dash of a vehicle. It also views the characteristics and the functional controls.

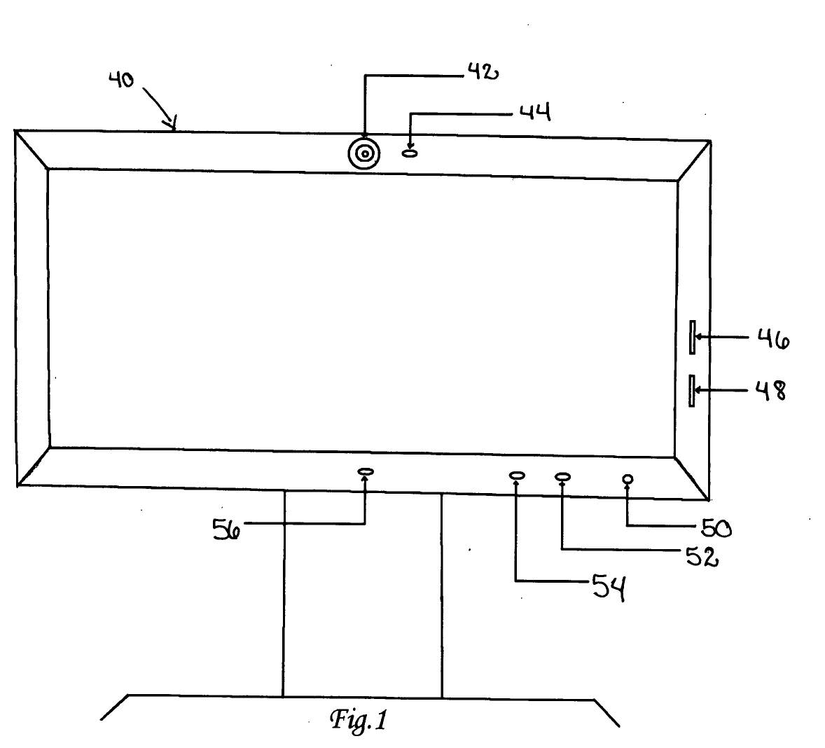

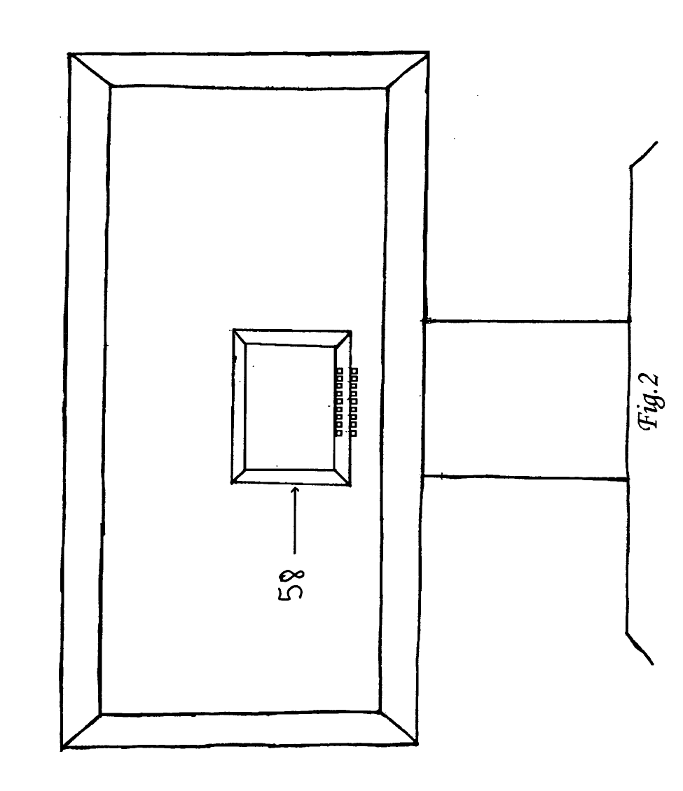

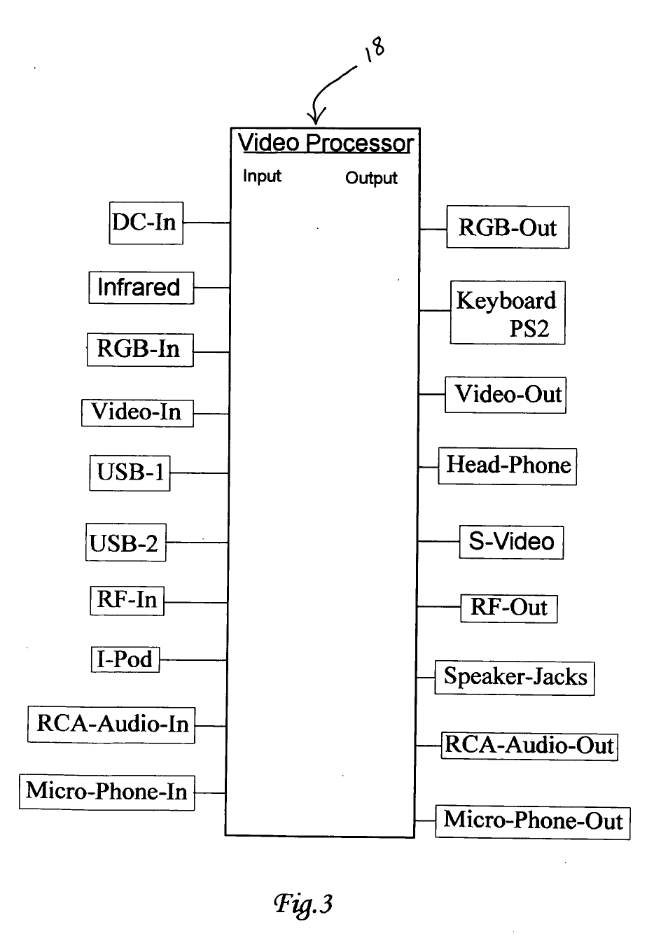

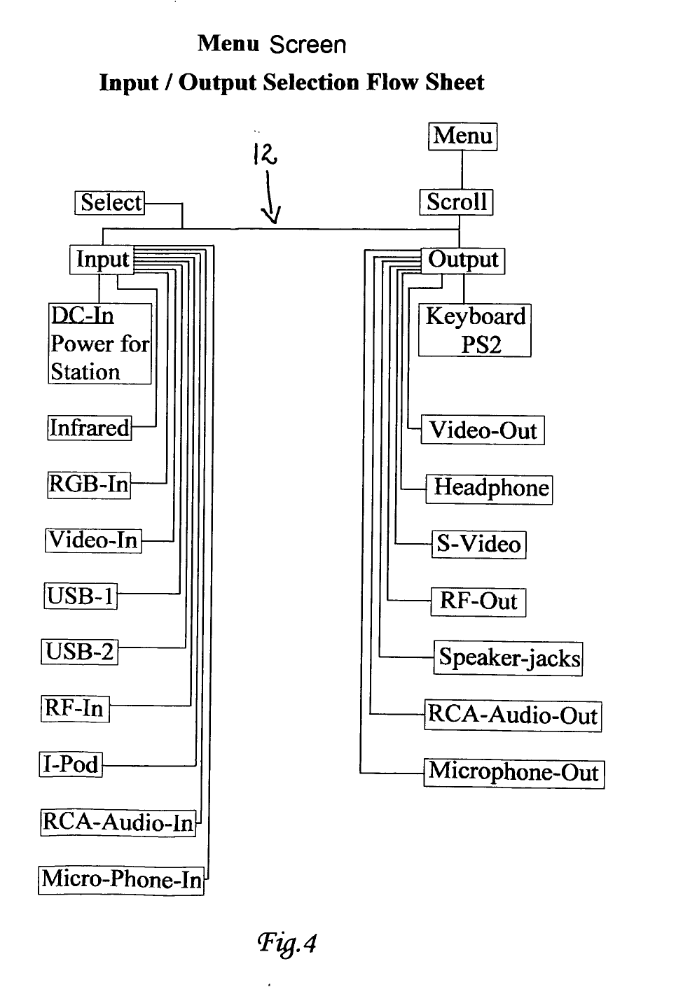

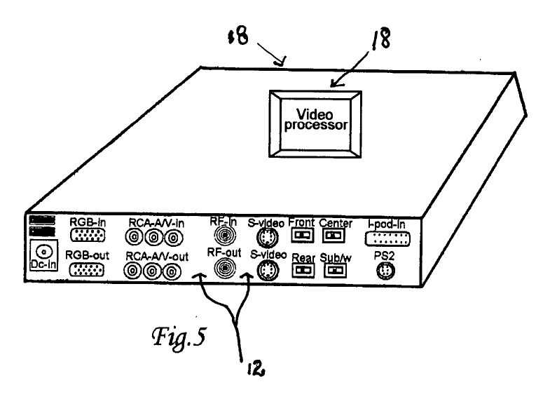

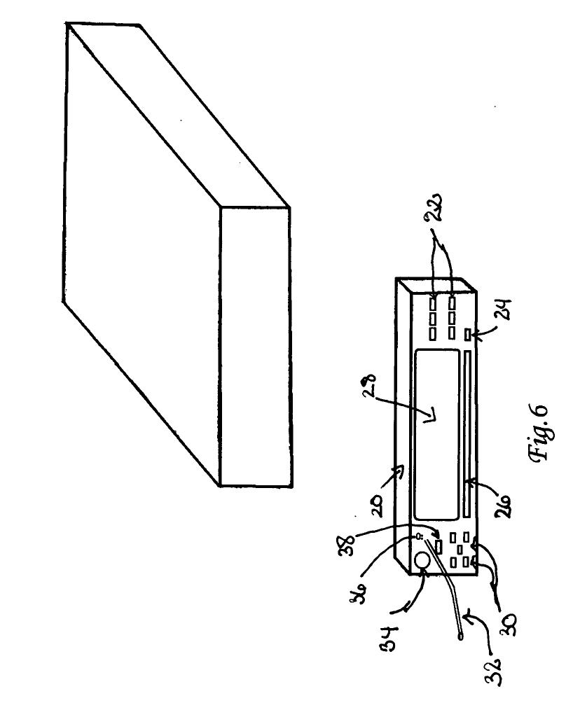

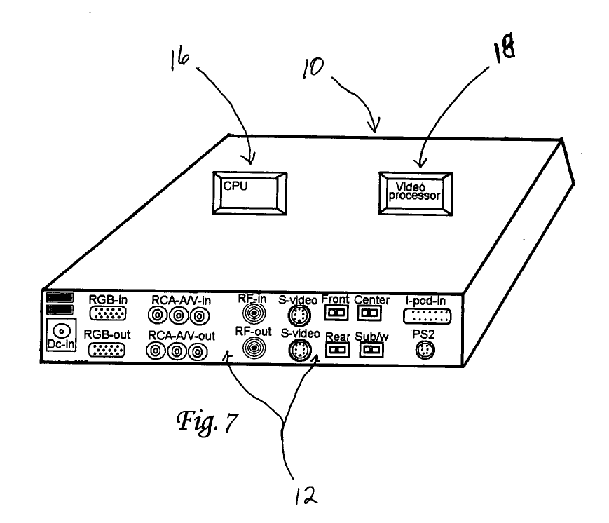

### DESCRIPTION OF THE PREFERED EMBODIMENTS

Referring to FIG. 7 This station is designed to give you the ability to perform multiple functions at the same time. For example, you can access the Internet 16, and at the same time you watch your favorite DVD movie or your favorite Television show 18. This station has a complete upgraded computer 16 that's intergraded with a video processors. The videoprocessor 18 will control all functions of the station. For example, video processor 18 will direct all signal traffic. For example, you can select 12 RCA input and S-video output or you can select two or three different inputs and outputs at the sometimes. Or you may select one input and all the outputs, which will allow the input signal to exit all the output ports. The station 18 can also direct audio signal direction. For example, you can send the audio to your headset or to the speaker jacks.

The station 18 has the capability of external speakers. The external speaker jacks have the extraordinary capability of giving you digital surround sound. The speakers that are installed inside the unit 10 will also provide digital surround sound.

The video processor portion 18 has multiple ports for outstanding capabilities. Remote controller can control the ports used by the video processor. The video processor 18 has its own DVD+RW driver 46 and it has the ability to burn incoming audio and video signals to a CD.

The computer portion 16 of the station also has a DVD+RW driver 48 and it has a built in wireless modem and remote modem. The computer 16, the video processor 18, and a projector are all internally linked together. It will have an external wire lead 32 access for Infrared and remote controllability. This gives the ability to conceal your interface components in other areas.

The video cam 42 installed inside the monitor (LCD or Plasma TV 40, etc.) Allows for recording video or photograph. The video cam 42 can be operated by remote. The station will have a menu 28 display. The video processor portion 8 is designed to improve current automotive audio and video systems. The primary unit 58 of this station will be installed internally in the back of a LCD screen or Plasma TV 40, etc.

The desktop section 10 of the station is portable. It will have a hard plastic cover that cover the keyboard then it will fit inside computer case. Inside the case there will be an ultra thin flat screen monitor; size will very. This monitor will have a built-in cam 42. All three systems 8, 10, 40 that have been mentioned will also have an external infrared connection 32. The video processor part 18 of the station is the command center of the station. The video processor 18 will receive and process the input signal and allow you to program it to an output port. The number of inputs signals 12 directly corresponds to the of output functions. The video processor 18 will even distribute signals coming from the computer part 16 of the station. The video processor 18 will allow multiple (all) programs perform at the same time. This station 8, 10, 40 will need only the unique software that comes with it.

Capabilities:

Digital 5.1 surround sound
Complete remote
Internet access
Phone vision
Cable access
Satellite access
Surveillance capable
GPS tracking
DVD or CD burning capability
Cellular Phone

### The Video Processor System

The Video Processor and the Projector are internally connected to the Computer. They all work together.

Main System Control:

Supports all Input and Output signals.
Supports and Direct signals.

DVD+RW Driver:
DVD driver can be operated by remote control.

Inputs:
I-pod hook-up (satellite radio)
DC-in
USB
USB
RGB-in
RCA
RF-in
S-Video
Infrared
Micro-phone-in
Digital PC
   Outputs:
Speaker Jacks
Micro-Phone
Headphone
RF-out
RGB-out
Digital PC
RCA
   Computer Features:

Hardware:

CPU
Intel Pentium 4 processor provides the new generation power for high end performance

Speed:
2.80 Hz with Hyper-Threading Technology
   Dram Memory:
512 MB PC2700 DDR SDRAM MEMORY
   Hard Drive:
160 GB 7200 RPM ULTRA DMA Hard Drive
   PC Features and Connection:
(a) PS/2 Keyboard
(b) PS/2 Mouse
(c) Serial Port
(d) Microphone
(e) USB 2.0
(f) Monitor
(g) Ethernet
(h) Modem
(i) Infrared Transmission
(j) Fire Wire (IEEE 1394)

1. Reginald Leland Smith hereby claim all entities, all integrations, all combinations and arrangements of components in this patent application. The intergrading of said components, the software and the unique configuration of said components and software that make these units unmistakably different from all the rest.
